(19) United States
(12) Patent Application Publication
(10) Pub. No.: US 2018/0141216 A1
(43) Pub. Date: May 24, 2018

(54) ROBOTIC PAYMENT GRIP APPARATUS AND METHOD OF USE

(71) Applicant: Wal-Mart Stores, Inc., Bentonville, AR (US)

(72) Inventors: Timothy M. Fenton, Bentonville, AR (US); Christopher D. Johnson, Bentonville, AR (US)

(21) Appl. No.: 15/816,811

(22) Filed: Nov. 17, 2017

Related U.S. Application Data
(60) Provisional application No. 62/424,705, filed on Nov. 21, 2016.

(51) Int. Cl. B25J 9/16; B25J 15/00

(52) U.S. Cl. CPC B25J 9/1692; B25J 15/00

(57) ABSTRACT

In some embodiments, robotic payment card grip apparatuses are providing, comprising: a body comprising: an end base; a first extended wall extending from the end base to a distal end and a second extended wall extending from the end base; and a card gap defined between the first extended wall and the second extended wall wherein the first extended wall is separated from the second extended wall by the card gap; wherein each of the first and second extended walls comprises: an exterior robot end effector grip, and at least first and second alignment protrusions separated from each other by a grip area of the end effector grip and formed extending away from the grip area and away from the card gap and configured to guide an alignment of a robot end effector.

### CROSS-REFERENCE TO RELATED APPLICATION

This application claims the benefit of U.S. Provisional Application No. 62/424,705, filed Nov. 21, 2016, which is incorporated herein by reference in its entirety.

### TECHNICAL FIELD

This invention relates generally to enhancing gripping of a test payment card by robotic end effectors.

### BACKGROUND

There are many types of retail payment machines. These machines are repeatedly used over time by numerous customers. The reliability and consistency of these machines is critical to customer satisfaction and completing sales. Accordingly, there is a need to ensure the reliability of these machines and their use.

### BRIEF DESCRIPTION OF THE DRAWINGS

Disclosed herein are embodiments of systems, apparatuses and methods pertaining enhancing gripping of a test payment card by robotic end effectors. This description includes drawings, wherein:

FIG. 1 illustrates a simplified perspective view of an exemplary robotic payment card grip apparatus, in accordance with some embodiments.

FIG. 2 illustrates a simplified perspective base view of the exemplary card grip apparatus, in accordance with some embodiments.

FIG. 3 illustrates a simplified perspective, partially transparent view of the exemplary card grip apparatus, in accordance with some embodiments.

FIGS. 4-5 illustrate simplified perspective views of the exemplary card grip apparatus cooperated with an exemplary payment card, in accordance with some embodiments.

FIG. 6 illustrates a simplified perspective view of an exemplary robotic payment card grip apparatus, in accordance with some embodiments.

FIG. 7 illustrates a simplified perspective base view of an exemplary card grip apparatus, in accordance with some embodiments.

FIG. 8 illustrates a simplified perspective view of an exemplary card grip apparatus cooperated with an exemplary payment card, in accordance with some embodiments.

FIG. 9 illustrates a simplified block diagram of a card grip apparatus cooperated with a test payment card, and end effectors of a testing robot system clamping and supporting the card grip apparatus, in accordance with some embodiments.

FIG. 10 illustrates a simplified flow diagram of a process of enabling robotic end effectors to grip a payment card to be used in testing, in accordance with some embodiments.

FIG. 11 illustrates an exemplary system for use in implementing methods, techniques, devices, apparatuses, systems, servers, sources and testing systems, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, “some applications”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful in enhancing gripping of a test payment card by robotic end effectors. Some embodiments provide robotic payment card grip apparatuses. The card grip apparatuses can include a body that comprises an end base, first and second extended walls extending from the end base to distal ends of the first and second extended walls, and a card gap. The card gap is defined between the first extended wall and the second extended wall with the first extended wall being separated from the second extended wall by the card gap. In some implementations, each of the first and second extended walls includes an exterior robot end effector grip that is generally parallel with the card gap. Further, the card grip apparatus in some embodiments includes at least first and second alignment protrusions separated from each other by a grip area of the end effector grip. The alignment protrusions are formed extending away from the grip area and away from the card gap and configured to guide an alignment of a robot end effector.

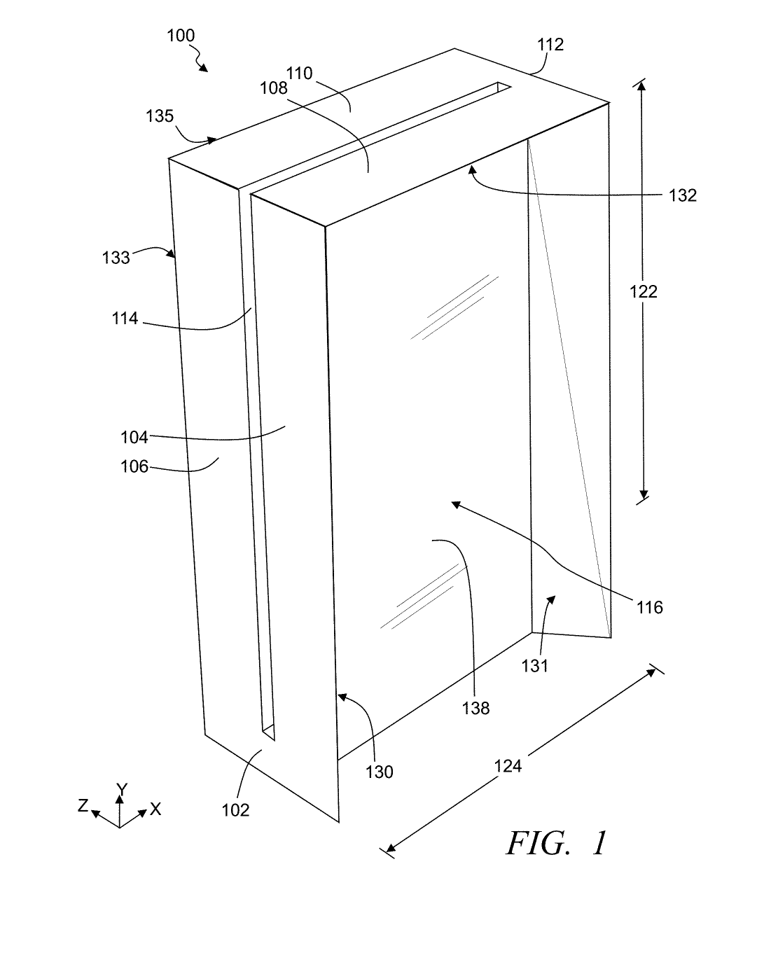

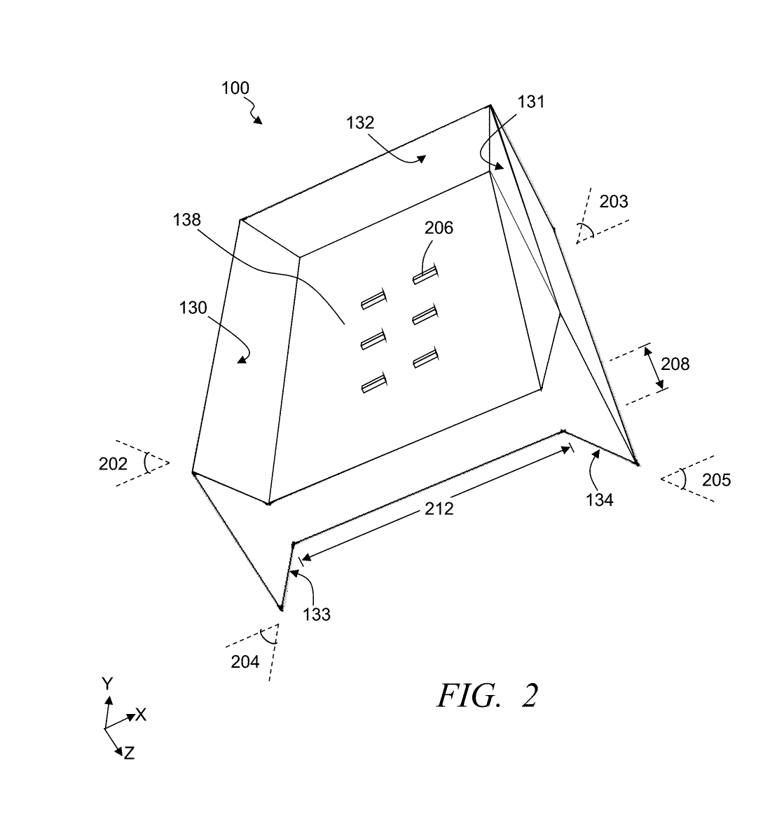

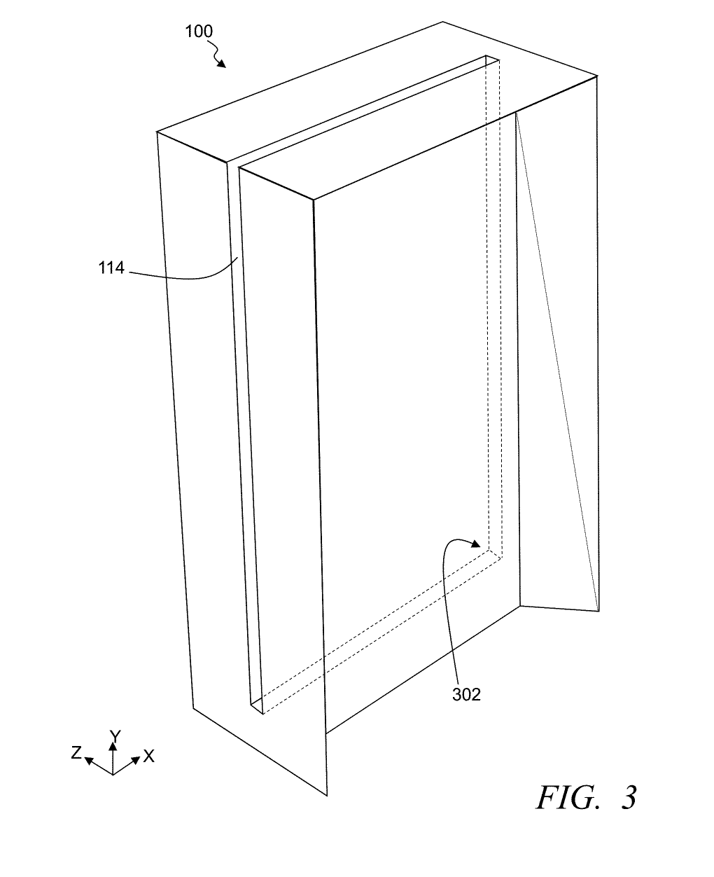

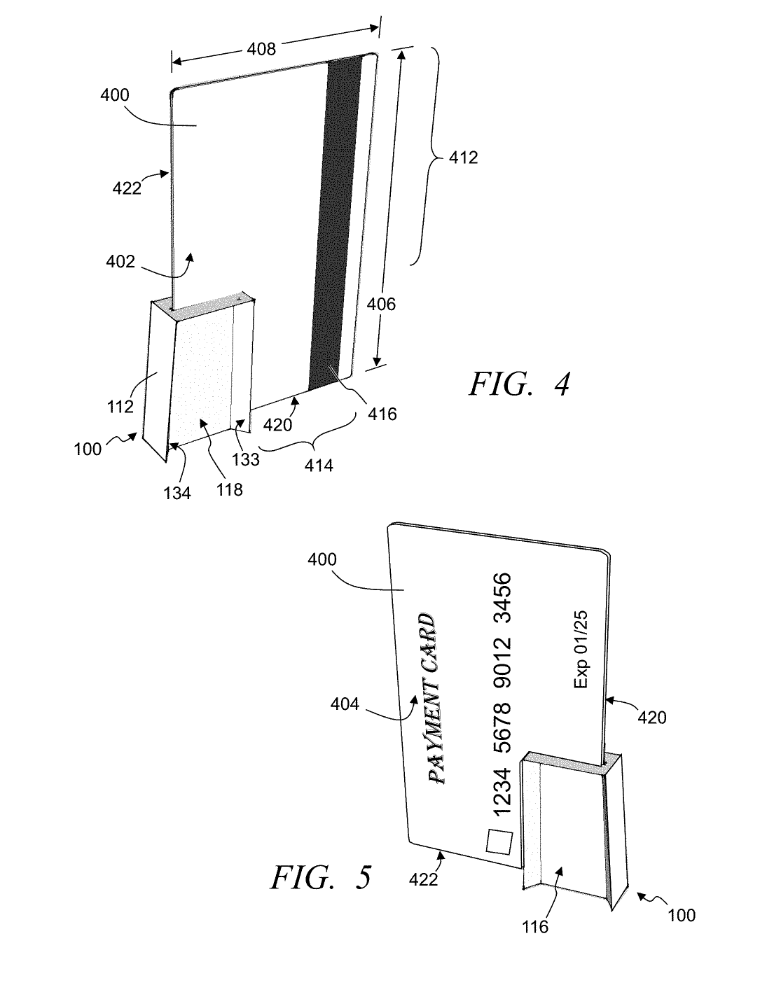

FIG. 1 illustrates a simplified perspective view of an exemplary robotic payment card grip apparatus 100, in accordance with some embodiments. The embodiment of the robotic payment card grip apparatus of FIG. 1 is an example of a corner card grip apparatus configured to cooperate with a corner of a payment card. FIG. 2 illustrates a simplified perspective base view of the exemplary card grip apparatus 100, in accordance with some embodiments. FIG. 3 illustrates a simplified perspective, partially transparent view of the exemplary card grip apparatus 100, in accordance with some embodiments. FIGS. 4-5 illustrate simplified perspective views of the exemplary card grip apparatus 100 of FIG. 1 cooperated with an exemplary payment card 400, in accordance with some embodiments.

Referring to FIGS. 1-5, the card grip apparatus has a body that includes an end base 102, and a first extended wall 104 and a second extended wall 106 extending from the end base 102 to first and second distal ends 108, 110, respectively. The card grip apparatus further includes a card gap 114 that is defined between the first extended wall 104 and the second extended wall 106, where the first extended wall is separated from the second extended wall by at least the card gap 114. Further, each of the first and second extended walls comprises an exterior robot end effector grip 116, 118, respectively. The end effector grips 116, 118 extend along at least a portion of a length 122 of the first and second extended walls, and extend across at least a portion of a width 124 of the first and second extended walls. Further, in some embodiments, end effector grips 116, 118 are formed generally parallel with the card gap 114.

The first and second extended walls optionally further include one or more alignment protrusions 130-132, 133-135, respectively. Typically, the first and second extended walls include at least two alignment protrusions positioned at lateral sides of the extended walls (sometimes referred to as lateral alignment protrusions). Some embodiments include a third alignment protrusions 132, 135 proximate the distal ends 108, 110 (sometimes referred to as distal end alignment protrusions). The side alignment protrusions 130-131 and 133-134 are separated from each other by a grip area 138 of the end effector grip 116. End alignment protrusions 132, 135 may also be included and bound at least a third side of the grip area 138. In some embodiments, the side alignment protrusions extend along at least portion of the length 122 to intersect and/or merge into the end alignment protrusions that extends along at least a portion of the width 124. In other implementations, the side alignment protrusions may be separate from the end alignment protrusion, and a gap may be defined between each side alignment protrusion and the end alignment protrusion. Further, in some embodiments, the end alignment protrusions 132, 135 are proximate the distal ends 108, 110 of the first and second extended walls, respectively, and are generally perpendicular to the side alignment protrusions.

Typically, the alignment protrusions 130-132, 133-135 are formed extending and protruding away from the grip area 138 and away from the card gap 114. In some embodiments, the alignment protrusions are configured to aid in aligning, and typically guiding an alignment of at least first and second robot end effectors that are positioned on opposite sides of the card grip apparatus 100. The alignment protrusions provide a more accurate and consistent positioning of the end effectors on the card grip apparatus. In some instances, the distance 212 or separation between the lateral alignment protrusions is about equal to a width of end effectors expected to be utilized in gripping the card grip apparatus; while in other instances, the separation between lateral alignment protrusions may be greater by at least a threshold distance than a width of expected end effectors predicted to be used to grip the card grip apparatus.

Further, some implementations form each of at least the side alignment protrusions 130-131, 133-134 with exterior alignment surfaces protruding at an alignment angle 202-205, respectively. Typically, the angles 202-205 of the exterior alignment surfaces are less than 90 degrees relative to the respective grip areas 138 and configured to guide an alignment of a robot end effector to align with the grip area. In some instances, for example, the angles 202-205 are about 45 degrees relative to a general plan defined relative to the respective grip areas 138. In other implementations, the angles of the alignment surfaces may be different, while in still other implementations, some angles may be the same while others are different (e.g., an angle of about 60 degrees for the end alignment protrusions, an angle of about 50 degrees for two of the side alignment protrusions, and an angle of about 35 degrees for the other two of the side alignment protrusions. The angles result in a tapering of the alignment protrusions such that the alignment protrusions gradually increase in thickness closer to the grip area and further from an exterior perimeter and exterior side surfaces and/or distal surfaces of the extended walls. The tapered surfaces in part guide the end effectors as they close and are within a threshold misalignment of the grip area to more accurately and consistently align with the grip area and an intended position on the grip areas.

The card grip apparatus, in some embodiments, does not include an alignment protrusion along the end base 102. This leaves open this edge of the card grip apparatus and can allow easier positioning and/or cooperation of the robot end effectors relative to the grip areas. Other embodiments, however, may include an alignment protrusion along at least a portion of the edge of the end base to further aid in aligning the end effectors. A positioning and/or start of an end alignment protrusion from a base edge can vary depending on one or more factors, and typically is a threshold distance from the base edge, which may be at least as long as a threshold length of an end effector predicted to be used to grip the card grip apparatus. In some applications, the threshold distance that end alignment protrusion is positioned form the base edge is defined to extend further along a length of the payment card such that the end effectors grip the payment card in a position along a length of the payment card to enhance stability of the payment card when clamped by the end effectors, such as at least a ⅕ of the length, in some instances at least ¼ the length of the card, and in some applications may depend on a location of a payment authentication portion of the payment card.

In some embodiments, the surfaces of the grip areas 138 may be and/or may include areas that are rough, non-smooth and/or include other such surface irregularities. The grip areas may include one or more dimples, bumps, texturing, contouring, protrusions, ribs, ridges, channels, other such surface variations and/or irregularities, or combinations of two or more of such surface irregularities. For example, one or both of the first and second extended walls 104, 106 may include a set of one or more surface irregularities 206 formed in and/or on a surface of the grip areas 138 (e.g., grip protrusions protruding from the surface of the grip areas). The surface variations can enhance the end effector's ability to grip and maintain a desired position of the card grip apparatus 100 and payment card 400 within the end effectors when clamped by the end effectors. The grip protrusions can have substantially any shape, such as but not limited to rectangular, cubic, pyramid, elongated triangular, semicircular, and/or other such shapes. Additionally or alternatively, the grip areas may include one or more recessed areas, channels, grooves, or the like. These surface irregularities may enhance gripping by the robotic end effectors and/or inhibit slipping from the end effectors.

Further, in some embodiments, the card grip apparatus 100 includes a lateral wall 112 that extends from at least one of the extended walls 104, 106 and at least partially closes the card gap 114 along one side of the corner card grip apparatus. In some implementations, the lateral wall 112 is secured with and/or continuous with both the extended walls. Further, the lateral wall may extend from the end base 102 along at least a portion of the length 122 of the first and second extended walls and/or card grip apparatus, and in some instances the full length of the card grip apparatus.

As illustrated in FIG. 3, the card gap 114 terminates at the lateral wall such that the first and second extended walls 1104, 106 and the lateral wall 112 define an interior corner 302. In some instances, the corner 302 may be rounded, while in other instances it is generally square shaped. The corner card grip apparatus can be positioned over a corner of a payment card 400 and along two edges (e.g., first card edge 420 and second card edge 422) of the payment card with the corner of the payment card. In some embodiments, the interior corner 302 of the payment card grip apparatus 100 is defined by the end base 102, the first and second extended walls 104, 106, and the lateral wall 112. The lateral wall, in some embodiments, extends from the end base and between the first and second extended walls along at least a portion of a length 122 of the first and second extended walls.

The card gap 114 is configured to receive a test payment card 400. While in the card gap, compression forces on the exterior grip areas 138 of the card grip apparatus causes interior surfaces of the extended walls 104, 106 to contact and be forced against the opposing sides 402 of the test payment card. Typically, the extended walls are formed to enable movement of at least portions of the extended walls relative to the end base 102 allowing the compression forces on the grip areas 138 to be transferred by the interior surface of the extended walls (e.g., by robot end effectors) to the sides 402 of the test payment card inducing a clamping force on the test payment card. The enhanced thickness 208 of the end effector grip 116 of the card grip apparatus enables the robot end effectors to more readily grip and hold the test payment card while utilizing the test payment card to test a system, such as a card payment system. The thickness of the first and second extended walls can depend on one or more factors, such as but not limited to a separation between end effectors when closed, a clamping force to be applied, an expected compression of the first and second extended walls as a result of clamping forces, type of end effectors expected to be used, a thickness of a card to be used, and/or other such factors. In some instances, the thickness of the extended walls at the grip area 138 is at least that of the thickness of a card expected to be inserted into the card gap resulting in a thickness 208 at the grip area of about three times the thickness of the expected card. In other instances, the thickness of the first and second extended walls, however, may be thinner or thicker than the expected card depending on one or more of the factors. Similarly, the depth or height of the alignment protrusions above the surface of the grip area can depend on one or more of the above factors, expected margins of error of misalignment of the end effectors, the alignment angles of one or more of the alignment protrusions, other such factors, or combination of two or more of such factors.

As illustrated in FIGS. 4-5, in some embodiments, the lateral wall 112 in part provides an alignment of and positions the test payment card 400 within the card gap 114. Further, the positioning of the test payment card relative to the end effectors is known to a testing robot based on the enhanced alignment of the robot end effectors in gripping the card grip apparatus provided in part by the alignment protrusions. In some embodiments, the first and second extended walls 104, 106 comprise a length 122 and width 124 that are less than a length 406 and width 408 of a payment card 400 configured to be received in the card gap 114. As such, at least a threshold length 412 and threshold width 414 of the payment card is external to the card gap with a payment authentication portion 416 (e.g., a magnetic strip, authentication chip, RFID chip and/or tag, etc.) of the payment card exposed and not covered by card grip apparatus.

As described above, in some embodiments, the first extended wall 104 is separated from the second extended wall 106 forming the card gap such that at least a portion of each of the first extended wall and the second extended wall are configured to exert a clamping force onto the payment card 400 when positioned within the card gap. This clamping force by the extended walls may be independent of any force exerted by the end effectors. The extended wall induced clamping force helps to maintain the position of the card grip apparatus on the test card when not being used and/or clamped by the robot end effectors. Further, the end extended wall induced clamping force typically allows the card grip apparatus to be readily removed from the test payment card. In some implementations, the card gap is configured with a width over at least a portion of the length of the card gap that is less than a width of the payment card expected to be inserted into the card gap. Additionally or alternatively, in some embodiments each of the first and second extended walls comprises one or more tapered ridges formed along a respective interior surface at least proximate to and/or at the distal end defining the separation between the first and second extended walls being less at the distal end of the first and second extended walls than the separation between the first and second extended walls proximate a central area of the end base. In some implementations, the width of the card gap may decrease along the length of the extended walls. When gripped by robot end effectors, end effectors further apply a clamping force to the first and second extended walls that is transferred by the first and second extended walls to the opposite sides of the test payment card, which in some instances may further enhancing the clamping force, and inhibits the test payment card from being removed from the card gap, and typically inhibiting the test payment card from being partially removed from the card gap. This improves the accuracy and consistency of the placement of the payment card for use in subsequent testing of one or more test machines.

The card grip apparatus 100 can be constructed from substantially any relevant material having the structural integrity to receive the payment card, and in some instances transfer clamping forces from the robot end effectors. For example, the card grip apparatus may be constructed from polylactic acid (PLA), Acrylonitrile butadiene styrene (ABS), plastics, carbon fiber impregnated PLA, rubber, silicon, aluminum, other metals, other such materials, or combination of two or more of such materials. The material may be at least partially flexible and/or elastically compressible. In some instances, some or all of the card grip apparatus may be formed from layering of materials cooperatively merge forming the portions or all of the card grip apparatus. Further, in some embodiments, the card grip apparatus or portions of the card grip apparatus can be formed through three-dimensional (3D) printing processes. In other implementations, the card grip apparatus or portions of the support apparatus may be manufactured through injection molding, machining, other such methods, or combination of two or more of such methods. Typically, the card grip apparatus is constructed such that the extended walls 104 and 106 elastically flex relative to the end base 102 and in some instances the lateral wall 112 further enhancing the transfer of clamping forces by the end effector to the interior surfaces of the extended walls on the opposing side surfaces of payment card. In 3D printing, some embodiments initiate the printing at the base end and continue to print along the length of the card grip apparatus with the card gap defined between the extended walls. The printing can include printing a tapering on the edges of the extended walls proximate the openings of the card gap.

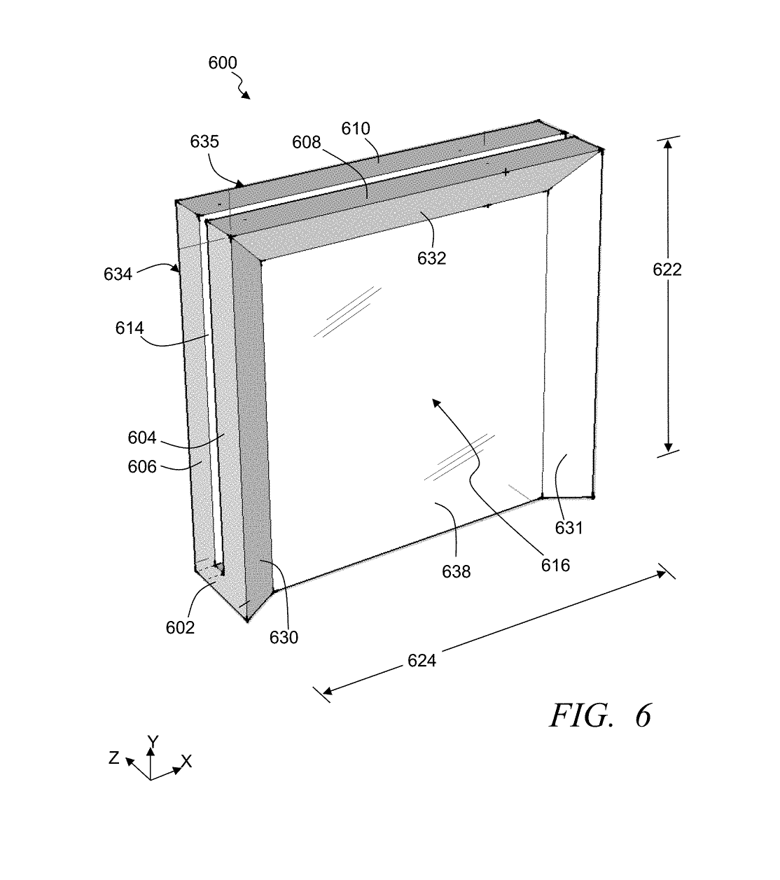

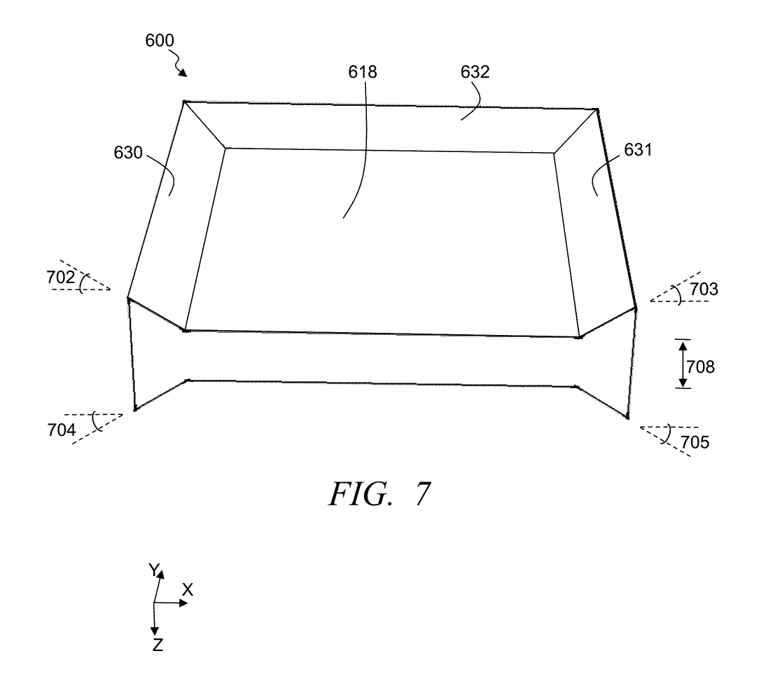

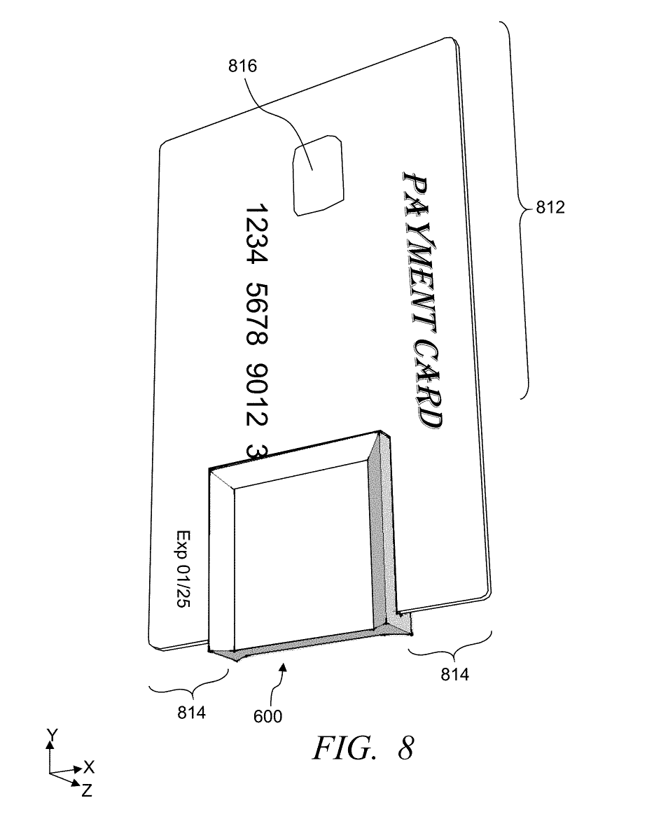

FIG. 6 illustrates a simplified perspective view of an exemplary robotic payment card grip apparatus 600, in accordance with some embodiments. The embodiment of the robotic payment card grip apparatus of FIG. 6 is an example of an edge card grip apparatus configured to cooperate with a corner of a payment card. FIG. 7 illustrates a simplified perspective base view of the exemplary card grip apparatus 600 of FIG. 6, in accordance with some embodiments. FIG. 8 illustrates a simplified perspective view of the exemplary card grip apparatus 600 of FIG. 6 cooperated with an exemplary payment card 400, in accordance with some embodiments.

Referring to FIGS. 6-8, the card grip apparatus 600 has a body that includes an end base 602, and a first extended wall 604 and a second extended wall 606 extending from the end base 602 to first and second distal ends 608, 610, respectively. The card grip apparatus further includes a card gap 614 that is defined between the first extended wall 604 and the second extended wall 606, where the first extended wall is separated from the second extended wall by at least the card gap 614. Further, each of the first and second extended walls comprises an exterior robot end effector grip 616. The end effector grips extend along at least a portion of a length 622 of the first and second extended walls, and extend across at least a portion of a width 624 of the first and second extended walls. Further, in some embodiments, end effector grips 616 are formed generally parallel with the card gap 614.

The first and second extended walls optionally further include one or more alignment protrusions 630-632, 633-635, respectively. Typically, the first and second extended walls include at least two alignment protrusions positioned at lateral sides of the extended walls. Some embodiments include a third alignment protrusions 632, 635 proximate the distal ends 608, 610. The side alignment protrusions 630-631 and 633-634 are separated from each other by a grip area 638 of the end effector grip 616. End alignment protrusions 632, 635 may also be included and bound at least a third side of the grip area 638. In some embodiments, the side alignment protrusions extend along at least portion of the length 622 to intersect and/or merge into the end alignment protrusions that extends along at least a portion of the width 624. In other implementations, the side alignment protrusions may be separate from the end alignment protrusion, and a gap may be defined between each side alignment protrusion and the end alignment protrusion. Further, in some embodiments, the end alignment protrusions 632, 635 are proximate the distal ends 608, 610 of the first and second extended walls, respectively, and are generally perpendicular to the side alignment protrusions.

Typically, the alignment protrusions 630-632, 633-635 are formed extending and protruding away from the grip area 638 and away from the card gap 614. In some embodiments, the alignment protrusions are configured to aid in aligning, and typically guiding an alignment of at least first and second robot end effectors that are positioned on opposite sides of the card grip apparatus 600. The alignment protrusions provide a more accurate and consistent positioning of the end effectors on the card grip apparatus. In some instances, the distance or separation between the lateral alignment protrusions is about equal to a width of end effectors expected to be utilized in gripping the card grip apparatus; while in other instances, the separation between lateral alignment protrusions may be greater by at least a threshold distance than a width of expected end effectors predicted to be used to grip the card grip apparatus.

Further, some implementations form each of at least the side alignment protrusions 630-631, 633-634 with exterior alignment surfaces protruding at an alignment angle 702-705, respectively. Typically, the angles 702-705 of the exterior alignment surfaces are less than 90 degrees relative to the respective grip areas 638 and configured to guide an alignment of a robot end effector to align with the grip area. In some instances, for example, the angles 702-705 are about 45 degrees relative to a general plan defined relative to the respective grip areas 638. In other implementations, the angles of the alignment surfaces may be different, while in still other implementations, some angles may be the same while others are different (e.g., an angle of about 60 degrees for the end alignment protrusions, an angle of about 55 degrees for two of the side alignment protrusions, and an angle of about 40 degrees for the other two of the side alignment protrusions. The angles result in a tapering of the alignment protrusions such that the alignment protrusions gradually increase in thickness closer to the grip area and further from an exterior perimeter and exterior side surfaces and/or distal surfaces of the extended walls. The tapered surfaces in part guide the end effectors as they close and are within a threshold misalignment of the grip area to more accurately and consistently align with the grip area and an intended position on the grip areas.

The card grip apparatus, in some embodiments, does not include an alignment protrusion along the end base 602. This leaves open this edge of the card grip apparatus and can allow easier positioning and/or cooperation of the robot end effectors relative to the grip areas. Other embodiments, however, may include an alignment protrusion along at least a portion of the edge of the end base to further aid in aligning the end effectors. A positioning and/or start of an end alignment protrusion from a base edge can vary depending on one or more factors, and typically is a threshold distance from the base edge, which may be at least as long as a threshold length of an end effector predicted to be used to grip the card grip apparatus. In some applications, the threshold distance that end alignment protrusion is positioned form the base edge is defined to extend further along a length of the payment card such that the end effectors grip the payment card in a position along a length of the payment card to enhance stability of the payment card when clamped by the end effectors, such as at least a ⅕ of the length, in some instances at least ¼ the length of the card, and in some applications may depend on a location of a payment authentication portion of the payment card.

In some embodiments, the surfaces of the grip areas 638 may be and/or may include areas that are rough, non-smooth and/or include other such surface irregularities. The grip areas may include one or more dimples, bumps, texturing, contouring, protrusions, ribs, ridges, channels, other such surface variations and/or irregularities, or combinations of two or more of such surface irregularities. For example, one or both of the first and second extended walls 604, 606 may include a set of one or more surface irregularities formed in and/or on a surface of the grip areas 638 (e.g., grip protrusions protruding from the surface of the grip areas). The surface variations can enhance the end effector's ability to grip and maintain a desired position of the card grip apparatus 600 and payment card 400 within the end effectors when clamped by the end effectors. Additionally or alternatively, the grip areas may include one or more recessed areas, channels, grooves, or the like, that may enhance gripping by the robotic end effectors and/or inhibit slipping from the end effectors.

In some embodiments, card gap 614 of the edge card grip apparatus 600 extends along the length 624 of the edge card grip apparatus, and the card gap is open at both ends. Accordingly, the extended walls 604, 606 are separated by the distance of the card gap including at both lateral sides of the card grip apparatus. The open card gap enables the card grip apparatus to be positioned on an edge of a payment card, and further allows the payment card to extend beyond one or both of the lateral sides of the card grip apparatus.

The card gap 614 is configured to receive the test payment card 400. While in the card gap, compression forces on the exterior grip areas 638 of the card grip apparatus causes interior surfaces of the extended walls 604, 606 to be forced against the opposing sides 402 of the test payment card. Typically, the extended walls are formed to enable movement of at least portions of the extended walls relative to the end base 602 allowing the compression forces on the grip areas 638 to be transferred by the interior surface of the extended walls (e.g., by robot end effectors) to the sides 402 of the test payment card inducing a clamping force on the test payment card. The enhanced thickness 708 of the effector grip 616 of the card grip apparatus enables the robot end effectors to more readily grip and hold the test payment card while utilizing the test payment card to test a system, such as a card payment system.

As illustrated in FIG. 8, in some embodiments, the card grip apparatus can be positioned along an edge of the test payment card with a portion of the test payment card protruding from the card gap 614 and beyond the length 622 of the extended walls 604, 606. Further, the positioning of the test payment card relative to the end effectors is known to a testing robot based on the enhanced alignment of the robot end effectors in gripping the card grip apparatus provided in part by the alignment protrusions. In some embodiments, the first and second extended walls 604, 606 comprise a length 622 and width 624 that are less than a length 406 and width 408 of the test payment card 400 configured to be received in the card gap 614. As such, at least a threshold length 812 of the payment card is external to the card gap with a payment authentication portion 816 (e.g., authentication chip, magnetic strip, RFID chip and/or tag, etc.) of the payment card exposed and not covered by card grip apparatus. In some applications, the card grip apparatus can be cooperated with the test payment card with one or more threshold widths 814 extending beyond the lateral sides of the card grip apparatus.

As described above, in some embodiments, the first extended wall 604 is separated from the second extended wall 606 forming the card gap such that at least a portion of each of the first extended wall and the second extended wall are configured to exert a clamping force onto the payment card 400 when positioned within the card gap. This clamping force by the extended walls may be independent of any force exerted by the end effectors. The extended wall induced clamping force helps to maintain the position of the card grip apparatus on the test card when not being used and/or clamped by the robot end effectors. Further, the end extended wall induced clamping force typically allows the card grip apparatus to be readily removed from the test payment card. In some implementations, the card gap is configured with a width over at least a portion of the length of the card gap that is less than a width of the payment card expected to be inserted into the card gap. Additionally or alternatively, in some embodiments each of the first and second extended walls comprises one or more tapered ridges formed along a respective interior surface at least proximate to and/or at the distal end defining the separation between the first and second extended walls being less at the distal end of the first and second extended walls than the separation between the first and second extended walls proximate a central area of the end base. In some implementations, the width of the card gap may decrease along the length of the extended walls. When gripped by robot end effectors, end effectors further apply a clamping force to the first and second extended walls that is transferred by the first and second extended walls to the opposite sides of the test payment card, which in some instances may further enhancing the clamping force, and inhibits the test payment card from being removed from the card gap, and typically inhibiting the test payment card from being partially removed from the card gap. This improves the accuracy and consistency of the placement of the payment card for use in subsequent testing of one or more test machines.

The card grip apparatus 600 can be constructed from substantially any relevant material having the structural integrity to receive the payment card, and in some instances transfer clamping forces from the robot end effectors. For example, the card grip apparatus may be constructed from polylactic acid (PLA), Acrylonitrile butadiene styrene (ABS), plastics, carbon fiber impregnated PLA, rubber, silicon, aluminum, other metals, other such materials, or combination of two or more of such materials. The material may be at least partially flexible and/or elastically compressible. In some instances, some or all of the card grip apparatus may be formed from layering of materials cooperatively merge forming the portions or all of the card grip apparatus. Further, in some embodiments, the card grip apparatus or portions of the card grip apparatus can be formed through three-dimensional (3D) printing processes. In other implementations, the card grip apparatus or portions of the support apparatus may be manufactured through injection molding, machining, other such methods, or combination of two or more of such methods. Typically, the card grip apparatus is constructed such that the extended walls 604 and 606 elastically flex relative to the end base 602 further enhancing the transfer of clamping forces by the end effector to the interior surfaces of the extended walls on the opposing side surfaces of payment card. In 3D printing, some embodiments initiate the printing at the base end and continue to print along the length of the card grip apparatus with the card gap defined between the extended walls. The printing can include printing a tapering on the edges of the extended walls proximate the openings of the card gap.

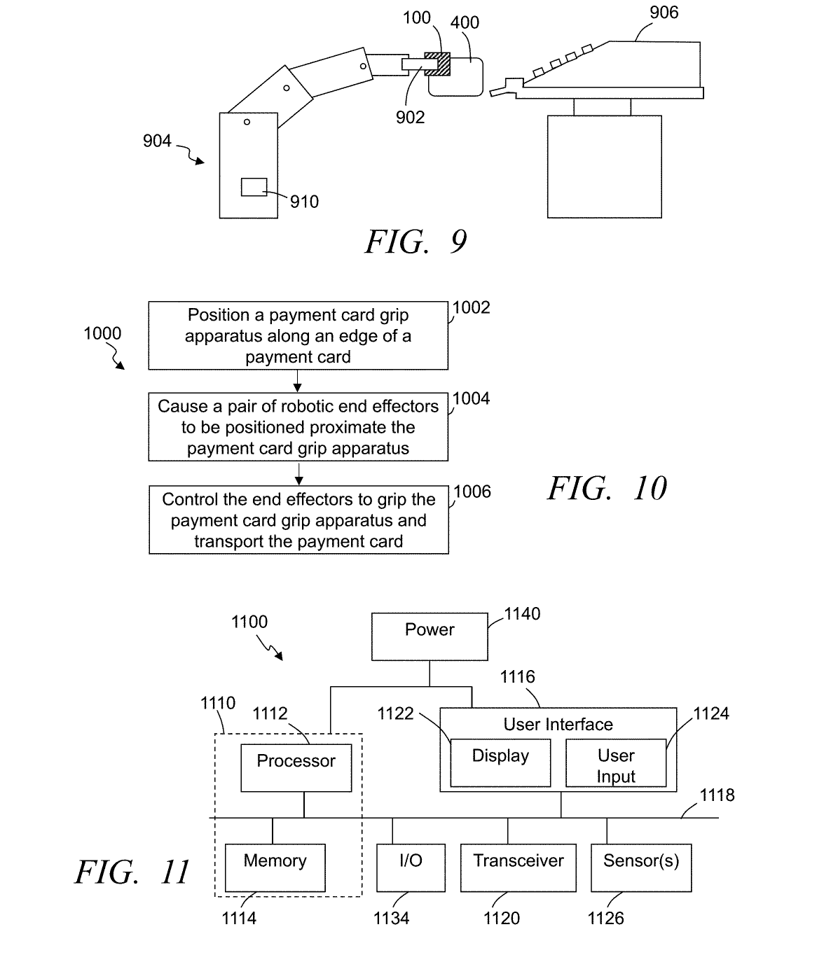

FIG. 9 illustrates a simplified block diagram of a card grip apparatus 100 cooperated with a test payment card 400, and end effectors 902 of a testing robot system 904 clamping and supporting the card grip apparatus 100, in accordance with some embodiments. The test robot system is positioned proximate a system to be tested, such as a card payment system 906. In operation, the testing robot can control the robotic end effectors 902 and position the end effectors on opposite sides of the card grip apparatus 100 and be activated to clamp on opposite sides of the card grip apparatus, and thus the test payment card. The robot can move the test payment card to interact with the card payment system 906. The test robot 904 typically includes one or more robot control systems 910 that controls at least the end effectors 902. Additionally or alternatively, the test robot is in wired and/or wireless communication with a control system that is at a remote location and that provides at least some control and/or programming to the robot control system. The test robot can, for example, be controlled to insert the test payment card into a payment and/or authentication slot, swipe an authentication strip along a magnetic strip reader groove, and/or other such testing. In some embodiments, the end effectors can more readily grip the card grip apparatus, and the card grip apparatus allows the end effectors to maintain a more precise positioning of the test payment card relative to a desired position relative to the card payment system. The robot can be configured to return the card grip apparatus and test payment card to a holding location and/or support apparatus while awaiting further instructions to perform additional testing and/or while the robot system utilizes a different test payment card and/or performs other actions (e.g., testing an user interface of the payment system, etc.).

The card grip apparatus enables the end effectors 902 to more securely hold the test payment card 400 and maintain a more precise positioning of the card. Further, there is less slippage of the card from an initial grip position allowing more accurate positioning of the test payment card relative to the test payment system and the relevant payment slots, slides or the like. The robot system can readily position the end effectors on opposite sides of the card grip apparatus and clamp on the opposing grip areas 138. The alignment protrusions further aid in aligning the end effectors onto the grip areas 138 and a more precise positioning on the card grip apparatus, and thus a more precise positioning relative to the dimensions of the test payment card 400.

FIG. 10 illustrates a simplified flow diagram of a process 1000 of enabling robotic end effectors 902 to grip a payment card 400 to be used in testing, in accordance with some embodiments. In step 1002, a payment card grip apparatus is positioned along an edge of a payment card 400 with a portion of the payment card inserted within a card gap of the payment card grip apparatus while exposing a payment authentication portion of the payment card. Typically, the card grip apparatus is positioned with an end base of the payment card grip apparatus adjacent the edge of the payment card, and in some instances abutting against and in contact with the edge of the payment card. The first and second extended walls extend from the end base, with the first extended wall being positioned along a first face of the payment card and a second extended wall being positioned along an opposing second face of the payment card. Some embodiments include applying an epoxy, glue or the like between one or more of the extended walls and the payment card. In step 1004, a pair of robotic end effectors are caused to be positioned proximate the payment card grip apparatus. In step 1006, the end effectors are controlled to grip the payment card grip apparatus and transport the payment card to a test location, which is typically where a system to be tested is positioned.

In positioning the payment card grip apparatus along the edge of the payment card, the card grip apparatus is typically positioned such that at least a threshold length of the payment card is external to the card gap with the payment authentication portion of the payment card exposed. Some embodiments automatically correct an alignment of the end effectors by in part passively directing at least one of the end effectors toward an exterior robot end effector grip of at least one of the extended walls in response to one or more of the end effectors contacting at least one of the alignment protrusions of the multiple alignment protrusions of the extended walls. The alignment protrusions are formed extending away from a grip area of the exterior robot end effector grip and away from the card gap. Further, the automatic correction of the alignment of the end effectors may further include passively aligning a depth of extension of at least one of the end effectors along a length of at least one of the extended walls in response to one or more of the end effectors contacting one of the distal end alignment protrusions of one or both of the extended walls, which are formed extending away from the grip area and the card gap. Further, some embodiments cause the pair of end effectors, in gripping the payment card grip apparatus, to contact grip protrusions protruding from a surface of the grip area of the exterior robot end effector grip of one or both of the first and second extended walls.

The payment card grip apparatus can be positioned along the edge of the payment card such that at least a portion of each of the first extended wall and the second extended wall are configured to exert a clamping force onto the payment card when positioned within the card gap. In some embodiments, the positioning of the payment card grip apparatus along the edge of the payment card comprises positioning the payment card grip apparatus over a corner of the payment card and along two edges 420, 422 of the payment card. Further, in some implementations, the payment card may be positioned with the corner of the payment card within an interior corner 302 of the payment card grip apparatus defined by the end base, the first and second extended walls, and a lateral wall that extending from the end base and between the first and second extended walls along at least a portion of a length of the first and second extended walls.

Further, the circuits, circuitry, systems, devices, processes, methods, techniques, functionality, services, servers, sources and the like described herein may be utilized, implemented and/or run on many different types of devices and/or systems. FIG. 11 illustrates an exemplary system 1100 that may be used for implementing any of the components, circuits, circuitry, systems, functionality, apparatuses, processes, or devices of the testing robot system 904, one or more remote testing control systems in communication with the testing robot system, and/or other above or below mentioned systems or devices, or parts of such circuits, circuitry, functionality, systems, apparatuses, processes, or devices. For example, the system 1100 may be used to implement some or all of robot control system 910, remote robot control system, the card payment system 906, and/or other such components, circuitry, functionality and/or devices. However, the use of the system 1100 or any portion thereof is certainly not required.

By way of example, the system 1100 may comprise a control circuit or processor module 1112, memory 1114, and one or more communication links, paths, buses or the like 1118. Some embodiments may include one or more user interfaces 1116, and/or one or more internal and/or external power sources or supplies 1140. The control circuit 1112 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 1112 can be part of control circuitry and/or a control system 1110, which may be implemented through one or more processors with access to one or more memory 1114 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 1100 may be used to implement one or more of the above or below, or parts of, components, circuits, systems, processes and the like. For example, the system may implement the robot control systems 910 with the control circuit being a robot control circuit, the card payment system 906 with a card payment control circuit, or other components.

The user interface 1116 can allow a user to interact with the system 1100 and receive information through the system. In some instances, the user interface 1116 includes a display 1122 and/or one or more user inputs 1124, such as buttons, touch screen, track ball, keyboard, mouse, etc., which can be part of or wired or wirelessly coupled with the system 1100. Typically, the system 1100 further includes one or more communication interfaces, ports, transceivers 1120 and the like allowing the system 1100 to communicate over a communication bus, a distributed computer and/or communication network (e.g., a local area network (LAN), the Internet, wide area network (WAN), etc.), communication link 1118, other networks or communication channels with other devices and/or other such communications or combination of two or more of such communication methods. Further the transceiver 1120 can be configured for wired, wireless, optical, fiber optical cable, satellite, or other such communication configurations or combinations of two or more of such communications. Some embodiments include one or more input/output (I/O) ports 1134 that allow one or more devices to couple with the system 1100. The I/O ports can be substantially any relevant port or combinations of ports, such as but not limited to USB, Ethernet, or other such ports. The I/O interface 1134 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 1126 to provide information to the system and/or sensor information that is communicated to another component, such as a central control system. The sensors can include substantially any relevant sensor, such as distance measurement sensors (e.g., optical units, sound/ultrasound units, etc.), applied forces, end effector clamping force, inertial sensors, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 1100 comprises an example of a control and/or processor-based system with the control circuit 1112. Again, the control circuit 1112 can be implemented through one or more processors, controllers, central processing units, logic, software and the like. Further, in some implementations the control circuit 1112 may provide multiprocessor functionality.

The memory 1114, which can be accessed by the control circuit 1112, typically includes one or more processor readable and/or computer readable media accessed by at least the control circuit 1112, and can include volatile and/or nonvolatile media, such as RAM, ROM, EEPROM, flash memory and/or other memory technology. Further, the memory 1114 is shown as internal to the control system 1110; however, the memory 1114 can be internal, external or a combination of internal and external memory. Similarly, some or all of the memory 1114 can be internal, external or a combination of internal and external memory of the control circuit 1112. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over a computer network (e.g., LAN, WAN, Internet, etc.). The memory 1114 can store code, software, executables, scripts, data, content, lists, programming, programs, log or history data, user information, and the like. While FIG. 11 illustrates the various components being coupled together via a bus, it is understood that the various components may actually be coupled to the control circuit and/or one or more other components directly.

Some embodiments provide robotic payment card grip apparatuses, comprising: a body comprising: an end base; a first extended wall extending from the end base to a distal end and a second extended wall extending from the end base; and a card gap defined between the first extended wall and the second extended wall wherein the first extended wall is separated from the second extended wall by the card gap; wherein each of the first and second extended walls comprises: an exterior robot end effector grip, and at least first and second alignment protrusions separated from each other by a grip area of the end effector grip and formed extending away from the grip area and away from the card gap and configured to guide an alignment of a robot end effector.

Further, some embodiments provide methods of enabling robotic end effectors to grip a payment card to be used in testing, comprising: positioning a payment card grip apparatus along an edge of a payment card with a portion of the payment card inserted within a card gap of the payment card grip apparatus while exposing a payment authentication portion of the payment card, and with an end base of the payment card grip apparatus adjacent the edge of the payment card and a first extended wall extending from the end base positioned along a first face of the payment card and a second extended wall extending from the end base positioned along an opposing second face of the payment card; and causing a pair of robotic end effectors to be positioned proximate the payment card grip apparatus and to grip the payment card grip apparatus and transport the payment card to a test location.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A robotic payment card grip apparatus, comprising:
a body comprising:
an end base;
a first extended wall extending from the end base to a distal end and a second extended wall extending from the end base; and
a card gap defined between the first extended wall and the second extended wall wherein the first extended wall is separated from the second extended wall by the card gap;
wherein each of the first and second extended walls comprises: an exterior robot end effector grip, and at least first and second alignment protrusions separated from each other by a grip area of the end effector grip and formed extending away from the grip area and away from the card gap and configured to guide an alignment of a robot end effector.

2. The apparatus of claim 1, wherein the first and second extended walls comprise a length and width that are less than a length and width of a payment card configured to be received in the card gap such that at least a threshold length of the payment card is external to the card gap with a payment authentication portion of the payment card exposed.

3. The apparatus of claim 1, wherein each of the first and second alignment protrusions comprise exterior alignment surfaces protruding at an angle of less than 90 degrees relative to the grip area and configured to guide an alignment of a robot end effector to align with the grip area.

4. The apparatus of claim 1, wherein each of the first and second extended walls further comprises a third alignment protrusion proximate the distal end and generally perpendicular to the first and second alignment protrusions.

5. The apparatus of claim 1, further comprising a lateral wall extending from the end base and between the first and second extended walls, and further extending along at least a portion of a length of the first and second extended walls defining an interior corner formed by the end base, the lateral wall and the first and second extended walls.

6. The apparatus of claim 1, wherein the first extended wall is separated from the second extended wall forming the card gap such that at least a portion of each of the first extended wall and the second extended wall are configured to exert a clamping force onto a payment card when positioned within the card gap.

7. The apparatus of claim 6, wherein each of the first and second extended walls comprises a tapered ridge formed along a respective interior surface at the distal end defining the separation between the first and second extended walls being less at the distal end of the first and second extended walls than the separation between the first and second extended walls proximate a central area of the end base.

8. The apparatus of claim 1, wherein each of the first and second extended walls comprise grip protrusions protruding from a surface of the grip area.

9. A method of enabling robotic end effectors to grip a payment card to be used in testing, comprising:
positioning a payment card grip apparatus along an edge of a payment card with a portion of the payment card inserted within a card gap of the payment card grip apparatus while exposing a payment authentication portion of the payment card, and with an end base of the payment card grip apparatus adjacent the edge of the payment card and a first extended wall extending from the end base positioned along a first face of the payment card and a second extended wall extending from the end base positioned along an opposing second face of the payment card; and
causing a pair of robotic end effectors to be positioned proximate the payment card grip apparatus and to grip the payment card grip apparatus and transport the payment card to a test location.

10. The method of claim 9, wherein the positioning the payment card grip apparatus along the edge of the payment card comprises positioning the payment card grip apparatus such that at least a threshold length of the payment card is external to the card gap with the payment authentication portion of the payment card exposed.

11. The method of claim 9, further comprising:
automatically correcting alignment of the end effectors comprising passively directing at least one of the end effectors toward an exterior robot end effector grip of the first extended wall in response to the at least one end effector contacting a first alignment protrusion of two or more alignment protrusions of the first extended wall formed extending away from a grip area of the exterior robot end effector grip and away from the card gap.

12. The method of claim 11, wherein the automatically correcting the alignment of the end effectors comprises passively aligning a depth of extension of the at least one end effector along a length of the first extended wall in response to the at least one end effector contacting a third alignment protrusion of the first extended wall formed extending away from the grip area and the card gap.

13. The method of claim 9, wherein the positioning the payment card grip apparatus along the edge of the payment card comprises positioning the payment card grip apparatus over a corner of the payment card and along two edges of the payment card with the corner of the payment card within an interior corner of the payment card grip apparatus defined by the end base, the first and second extended walls, and a lateral wall extending from the end base and between the first and second extended walls along at least a portion of a length of the first and second extended walls.

14. The method of claim 9, wherein the positioning the payment card grip apparatus along the edge of the payment card comprises positioning the payment card grip apparatus such that at least a portion of each of the first extended wall and the second extended wall are configured to exert a clamping force onto the payment card when positioned within the card gap.

15. The method of claim 9, wherein the causing the pair of end effectors to grip the payment card grip apparatus comprises causing the pair of end effectors to contact grip protrusions protruding from a surface of a grip area of an exterior robot end effector grip of the first extended wall.
